(19) United States
(12) Patent Application Publication
(10) Pub. No.: US 2004/0245861 A1
(43) Pub. Date: Dec. 9, 2004

(54) Linear motor, stage device having this linear motor, exposure device, and device manufacturing method

(75) Inventors: Yoshikazu Miyajima, Tochigi (JP); Hideo Tanaka, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/849,855

(22) Filed: May 21, 2004

(30) Foreign Application Priority Data
Jun. 3, 2003 (JP) 2003-158597

(51) Int. Cl. H02K 41/00

(52) U.S. Cl. 310/12

(57) ABSTRACT

The linear motor includes a Y annular coil (3) which is winded around a stator yoke (5) about a main drive axis in a form of a square cylinder, a Y moving element magnet (6) which two-dimensionally opposes the Y annular coil (3) via a predetermined gap, an X annular coil 11 which is fixed to the Y annular coil (3) via an insulating material (2), and an X moving element magnet (12) which two-dimensionally opposes the X annular coil (11) via a predetermined gap. The linear motor can drive the Y moving element magnet (6) in the main drive axis direction by energizing the Y annular coil (3), and drive the X moving element magnet (12) in the direction perpendicular to the main drive axis direction by energizing the X annular coil (11).

### FIELD OF THE INVENTION

The present invention relates to a linear motor which is used as an actuator for driving an object in at least a one-axis direction of three-dimensional directions (X-, Y-, and Z-axis directions), a stage device having this linear motor, an exposure apparatus, and a device manufacturing method.

### BACKGROUND OF THE INVENTION

FIG. 10A is a view showing an internal arrangement of a conventional annular linear motor viewed from an X-Z plane. FIG. 10B is a view showing the internal arrangement of the annular linear motor in FIG. 10A viewed from a Y-Z plane. FIG. 11 is a view corresponding to FIG. 10B, more specifically, showing a control circuit for energizing a Y annular coil 3 and X annular coil 11.

In FIGS. 10A and 10B and FIG. 11, reference numeral 101 denotes a support member which is a structure for supporting an overall stator. Reference numeral 102 denotes an insulating member which is used to prevent generation of a short circuit between a Y annular coil 103 and a stator yoke 105, and align the Y annular coil. The Y annular coil 103 is a square-cylindrical coil which winds a magnet wire so as to be formed into an almost quadrangle.

Reference numeral 104 denotes a cooling medium flow channel for cooling the coil, which is formed by hollowing almost the center of the support member 101 to remove heat generated in exciting the Y annular coil 103. At almost the center of the support member 101 as shown in FIGS. 10A and 10B, one cooling medium flow channel 104 may be formed, or a plurality of cooling medium flow channels 104 may be formed. Reference numeral 105 denotes the stator yoke which opposes a Y moving element magnet 106 fixed to a magnet stationary plate 107 which is a part of the moving element. The stator yoke 105 is made of a multilayered soft-iron member with a low coercive force, for example., a Permalloy steel plate, silicon steel plate, and particulate silicon steel plate.

The Y annular coil 103 is bonded to the insulating member 102 bonded to the stator yoke 105 further bonded to the support member 101.

The Y moving element magnet 106 which forms the linear motor moving element is attached inside the magnet stationary plate 107 on which a plurality of permanent magnets are connected in a form of an almost square cylinder in a direction perpendicular to the drawing surface (i.e., in a Halbach arrangement), so as to generate a two-cycle almost sine-wave magnetic field. The four Y moving element magnets 106 are respectively fixed on the four inner surfaces of the magnet stationary plate 107. A moving element arm 108 connected to one of the outer surfaces of the magnet stationary plates 107 is connected to the wafer stage and the like mounted on the semiconductor manufacturing device, thereby extracting a driving force of the actuator generated by a Lorentz force.

In the conventional arrangement, the linear motor which mounts the permanent magnet on the moving element side, which is the moving magnet-type linear motor has been described. However, a linear motor which mounts a coil on the moving element side, which is a moving coil-type linear motor may be used.

Reference numeral 109 denotes a coil switching circuit having a function of selecting the Y annular coil 103 to be excited, in accordance with the moving position of the Y moving element magnet 106. A driving current for exciting the coil is supplied from a motor driver 110.

Note that in Japanese Patent Laid-Open

No. 7-131966, a perpendicular coil is arranged in a single surface, and a moving magnet and yoke are arranged in matrix corresponding to the coil. Also, in Japanese Patent Laid-Open Nos. 2001-086725 and 2001-061269, a cylindrical linear motor and a method of cooling the coil are described.

However, the linear motor having a conventional cylindrical or square-cylindrical coil can be only driven in the Y-axis direction (i.e., a main drive axis direction), but cannot be driven in the direction other than the main drive axis direction. Hence, the degree of freedom of the driving direction is very limited.

### SUMMARY OF THE INVENTION

The present invention has been made in consideration of the above problem, and has as its object to, in a linear motor having a square-cylindrical coil, control the linear motor to drive in the direction other than the main drive axis direction, and control the position of component in the direction other than the main drive axis direction of the linear motor, thereby accurately aligning the linear motor.

In order to achieve the above problem, and achieve the object, according to the first aspect of the present invention, a linear motor comprises first driving means including a first stator which is annularly formed about a first drive axis, and a first moving element which two-dimensionally opposes the first stator via a predetermined gap, the first driving means driving the first moving element in a main drive axis direction by exciting any one of the first stator and the first moving element, and second driving means including a second stator which is fixed to the first stator, and a second moving element which two-dimensionally opposes the second stator via a predetermined gap, the second driving means driving the second moving element in a second direction substantially perpendicular to the main drive axis direction by exciting any one of the second stator and the second moving element.

According to the second aspect of the present invention, the linear motor of the first aspect, further comprises third driving means including a third stator which is fixed to the first stator, and a third moving element which two-dimensionally opposes the third stator via a predetermined gap, the third driving means driving the third moving element in a third direction substantially perpendicular to the main drive axis direction and second direction by exciting any one of the third stator and the third moving element.

According to the third aspect of the present invention, in the linear motor of the first or second aspect, the first stator includes a first coil annularly winded about the first drive axis, and first energizing means for energizing the first coil, and the first moving element includes a plurality of first permanent magnets opposing the first coil via a predetermined gap, and stationary portions which hold the first permanent magnets.

According to the fourth aspect of the present invention, in the linear motor of any one of the first to third aspects, the second stator includes a second coil substantially integrally fixed to the first coil, and second energizing means for energizing the second coil, and the second moving element includes a plurality of second permanent magnets opposing the second coil via a predetermined gap, and stationary portions which hold the second permanent magnets.

According to the fifth aspect of the present invention, in the linear motor of any one of the second to fourth aspects, the third stator includes a third coil which is substantially integrally fixed to the first stator, and third energizing means for energizing the third coil, and the third moving element includes a plurality of third permanent magnets opposing the third coil via a predetermined gap, and stationary portions which hold the third permanent magnets.

According to the sixth aspect of the present invention, in the linear motor of the fourth or fifth aspect, the second and third coils are annular coils, the second coil includes a linear portion in substantially parallel to the main drive axis, and the second and third coils oppose each other in substantially parallel to a second direction, and the third coil is arranged to include a linear portion in substantially parallel to the main drive axis.

According to the seventh aspect of the present invention, in the linear motor of the fourth or fifth aspect, the stationary portion commonly supports the first to third permanent magnets.

According to the eighth aspect of the present invention, in the linear motor of the first or second aspect, the first moving element includes a first coil annularly winded about the first drive axis, and first energizing means for energizing the first coil, and the first stator includes a plurality of first permanent magnets opposing the first coil via a predetermined gap, and stationary portions which hold the first permanent magnets.

According to the ninth aspect of the present invention, in the linear motor of any one of the first to third aspects, preferably, the second moving element includes a second coil substantially integrally fixed to the first coil, and second energizing means for energizing the second coil, and the second stator includes a plurality of second permanent magnets opposing the second coil via a predetermined gap, and stationary portions which hold the second permanent magnets.

According to the tenth aspect of the present invention, in the linear motor of any one of the second to fourth aspects, the third moving element includes a third coil which is substantially integrally fixed to the first stator, and third energizing means for energizing the third coil, and the third stator includes a plurality of third permanent magnets opposing the third coil via a predetermined gap, and stationary portions which hold the third permanent magnets.

According to the present invention, a stage device comprises a linear motor of any one of first to tenth aspects, and a stage driven by the linear motor.

According to the present invention, an exposure device comprises a stage device of the eleventh aspect aligns at least one of a substrate and a master.

According to the present invention, a device manufacturing method comprises a step of manufacturing a device by using an exposure device of twelfth aspect.

As described above, according to the present invention, a linear motor having a square-cylindrical coil can control the linear motor to drive in the direction other than the main drive axis direction, and control the position of component in the direction other than the main drive axis direction of the linear motor, thereby accurately aligning the linear motor.

Other objects and advantages besides those discussed above shall be apparent to those skilled in the art from the description of a preferred embodiment of the invention which follows. In the description, reference is made to accompanying drawings, which form apart thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a view showing an internal arrangement of an annular linear motor viewed from an X-Z plane according to the first embodiment of the present invention;

FIG. 2 is a view showing the internal arrangement of the annular linear motor in FIG. 1 viewed from a Y-Z plane, and more specifically, showing a positional relationship between a Y annular coil 3 and Y moving element magnet 6;

FIG. 3A is a view corresponding to FIG. 1, and more specifically, partially showing the positional relationship between an X annular coil 11 and an X moving element magnet 12;

FIG. 3B is a view corresponding to FIG. 2, and more specifically, partially showing the positional relationship between the X annular coil 11 and the X moving element magnet 12;

FIG. 4A is a view corresponding to FIG. 3A, more specifically, showing a control circuit for energizing the Y annular coil 3 and the X annular coil 11;

FIG. 4B is a view corresponding to FIG. 2, more specifically, showing a control circuit for energizing the Y annular coil 3 and the X annular coil 11;

FIG. 5 is a view showing the internal arrangement of the annular linear motor viewed from an X-Z plane according to the second embodiment of the present invention;

FIG. 6 is a view showing the internal arrangement of the annular linear motor viewed from an X-Z plane according to the third embodiment of the present invention;

FIG. 7 is a view showing an example of the arrangement in which the linear motor in this embodiment is mounted on a stage device;

FIG. 8 is a view showing an exposure device for manufacturing a semiconductor device using the stage device in FIG. 7 as a wafer stage;

FIG. 9 is a flowchart showing the overall manufacturing process of the semiconductor device;

FIG. 10A is a view showing an internal arrangement of a conventional annular linear motor viewed from an X-Z plane;

FIG. 10B is a view showing the internal arrangement of the annular linear motor in FIG. 10A viewed from a Y-Z plane; and

FIG. 11 is a view corresponding to FIG. 10B, more specifically, showing a control circuit for energizing a Y annular coil 103.

### DETAILED DESCRIPTION OF THE PREFERRED EMBODIMENTS

Embodiments of the present invention will be described in detail with reference to the accompanying drawings.

[First Embodiment]

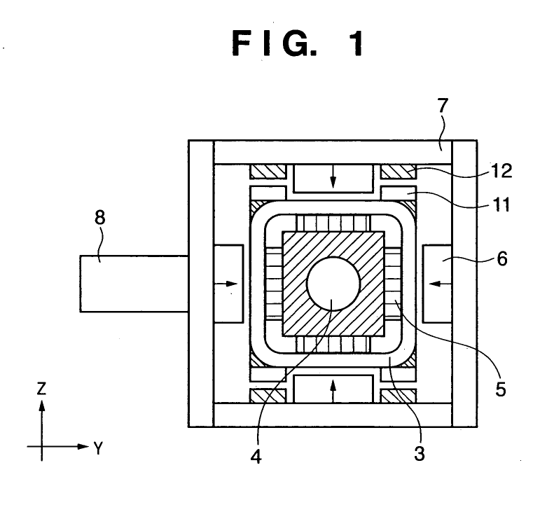

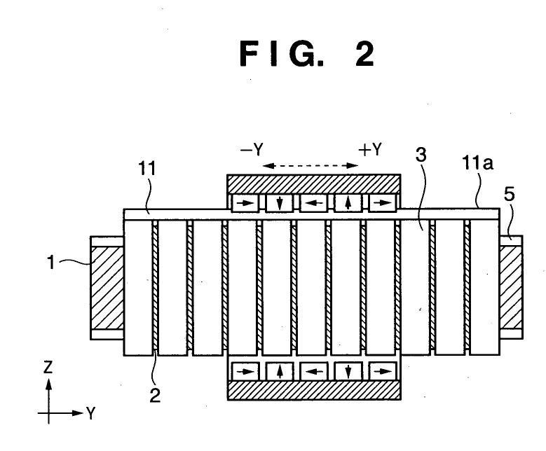

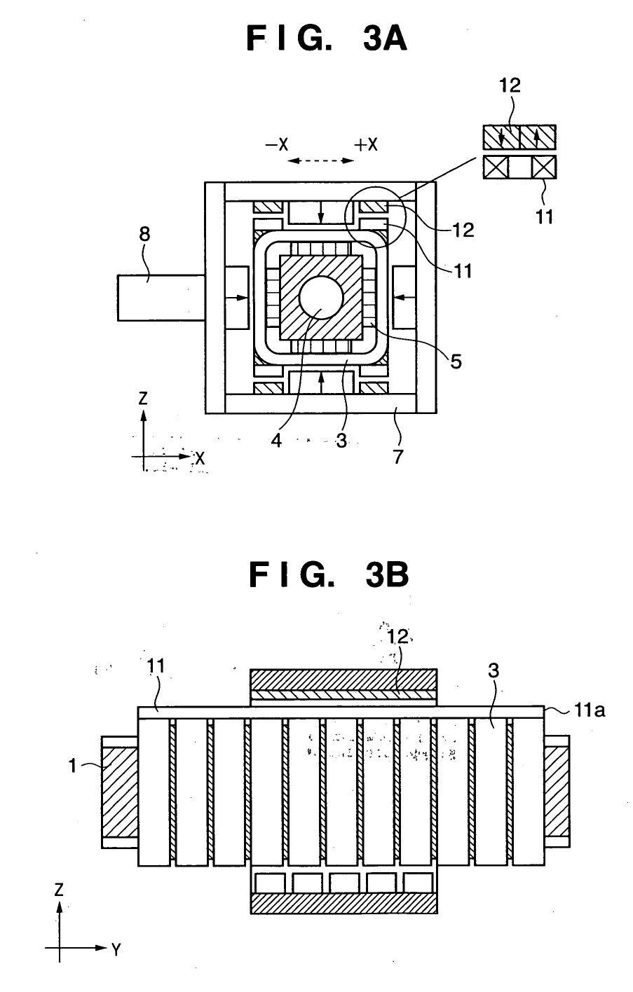

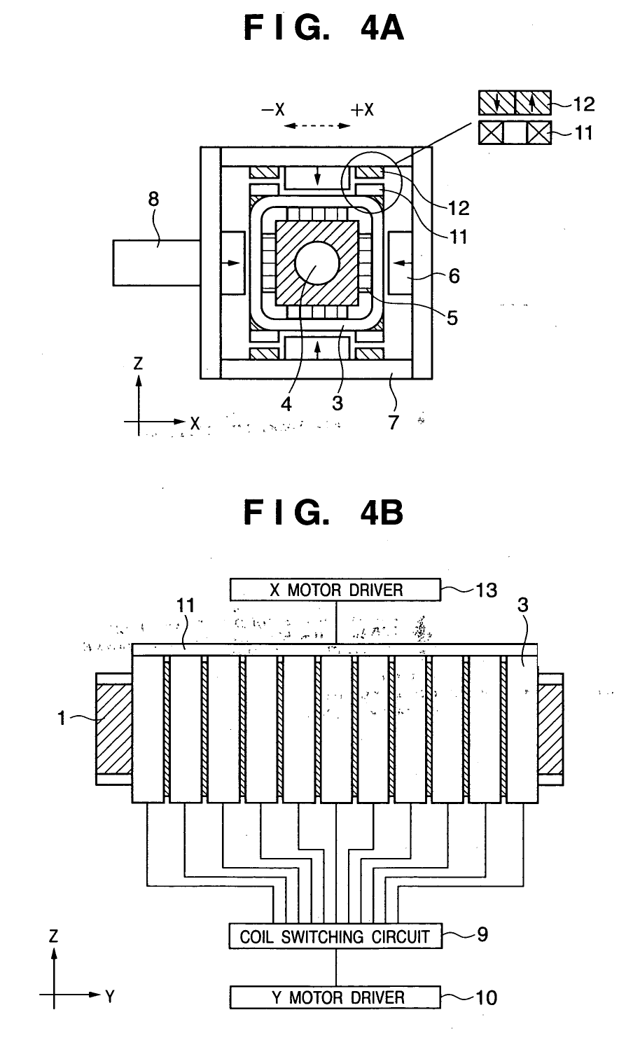

FIG. 1 is a view showing an internal arrangement of an annular linear motor viewed from an X-Z plane according to the first embodiment of the present invention. FIG. 2 is a view showing the internal arrangement of the annular linear motor in FIG. 1 viewed from a Y-Z plane, and more specifically, showing a positional relationship between a Y annular coil 3 and Y moving element magnet 6. FIG. 3A is a view corresponding to FIG. 1, and more specifically, partially showing the positional relationship between an X annular coil 11 and an X moving element magnet 12. FIG. 3B is a view corresponding to FIG. 2, and more specifically, partially showing the positional relationship between the X annular coil 11 and the X moving element magnet 12. Furthermore, FIG. 4A is a view corresponding to FIG. 3A, more specifically, showing a control circuit for energizing the Y annular coil 3 and the X annular coil 11. FIG. 4B is a view corresponding to FIG. 2, more specifically, showing a control circuit for energizing the Y annular coil 3 and the X annular coil 11.

Note that, as is apparent from the following description, reference symbol “X” denotes an element related to the movement in the X direction. Similarly, reference symbol “Y” denotes an element related to the movement in the Y direction.

In FIG. 1, reference numeral 1 denotes a support member which is a structure for supporting an overall stator. Reference numeral 102 denotes an insulating member which is used to prevent generation of a short circuit between the adjacent coils (between the adjacent Y annular coils 3, or between the Y annular coil 3 and the X annular coil 11), and between these adjacent coils and stator yokes 105 respectively, and align the respective coils. Note that since the general magnet coil has an insulating film on the outer surface of the coil, the insulating member need not be arranged. The Y annular coil 3 is an annular coil which winds a magnet wire so as to be formed into an almost quadrangle.

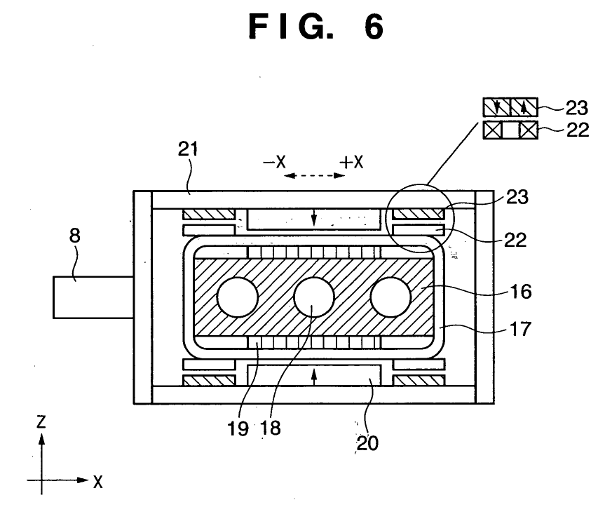

Reference numeral 4 denotes a cooling medium flow channel for cooling the coil, which is formed by hollowing almost the center of the support member 1 to remove heat generated in exciting the Y annular coil 3 and the X annular coil 11. At almost the center of the support member 1 as shown in FIG. 1, one cooling medium flow channel 4 may be formed, or a plurality of cooling medium flow channels 4 may be formed (see FIG. 6). Reference numeral 5 denotes a magnetic stator yoke which two-dimensionally opposes via a predetermined gap (an almost constant gap in the X and Y directions, and an almost constant gap in the Y and Z directions) a Y moving element magnet 6 and an X moving element magnet 12 fixed to a magnet stationary plate 7 which is a part of the moving element to generate a magnetic field. In order to prevent movement of the moving element by generating a magnetic hysteresis and eddy current, and to prevent the generation of the eddy current loss, the stator yoke 5 is made of a multilayered soft-iron member with a low coercive force, for example., a Permalloy steel plate, silicon steel plate, and particulate silicon steel plate. The stator yoke includes the moving element magnet and magnetic circuit, and magnetism is generated when the moving element magnet moves to oppose the yoke in order to close the magnetic circuit for the moving element magnet.

The Y annular coil 3 is bonded to the insulating member 2 bonded to the stator yoke 5 further bonded to the support member 1.

The Y moving element magnet 6 which forms the linear motor moving element is attached inside the magnet stationary plate 7 on which a plurality of permanent magnets are connected in a form of an almost square cylinder in a direction perpendicular to the drawing surface (i.e., in a Halbach arrangement), so as to generate a two-cycle almost sine-wave magnetic field. The four Y moving element magnets 6 are respectively fixed on the four inner surfaces of the magnet stationary plate 7. A moving element arm 8 connected to one of the outer surfaces of the magnet stationary plates 7 is connected to the wafer stage and the like mounted on the semiconductor manufacturing device, thereby extracting a driving force of the actuator generated by a Lorentz force.

Reference numeral 9 denotes a coil switching circuit having a function of selecting the Y annular coil 3 to be excited, in accordance with the moving position of the Y moving element magnet 6. A driving current for exciting the coil is supplied from a motor driver 10.

The X annular coil 11 is an air-core coil bonded to the corner on the outer surface of the Y annular coil 3 via the insulating member 2. As shown in FIGS. 3A and 3B, the X annular coil 11 includes a linear portion 11a in parallel to a main drive axis.

Reference numeral 12 denotes the X moving element magnet which two-dimensionally opposes the X annular coil 11 via a predetermined gap (an almost constant gap in the X and Y directions). The X moving element magnets 12 are formed on the both sides of the Y moving element magnet 6. The pairs of the X moving element magnets 12 are fixed on the two surfaces of the magnet stationary plates 7 in parallel to the X-Y plane.

As shown in FIGS. 4A and 4B, reference numeral 13 denotes an X motor driver which supplies a driving current for exciting the X annular coil 11. Since the X motor driver 13 supplies the driving current to the X annular coil 11, the magnet stationary plate 7, which is the moving element arm 8 is driven in the +X direction almost perpendicular to the main drive axis direction.

In the conventional arrangement, the linear motor which mounts the permanent magnet on the moving element side, which is the moving magnet-type linear motor has been described. However, a linear motor which mounts a coil on the moving element side, which is a moving coil-type linear motor may be used.

When the linear motor is arranged as the moving coil-type linear motor (the moving coil-type linear motor can be applied in the second and third embodiments to be described below), the magnet stationary plate 7 and a member supported by the magnet stationary plate 7 may serve as stators, and the stator yoke 5 and a member supported by the stator yoke 5 may serve as moving elements. Alternatively, the Y annular coil 3, cooling medium flow channel 4, stator yoke 5, and X annular coil 11 serve as moving elements arranged on the magnet stationary plate 7 side, and the Y moving element magnet 6 and X moving element magnet 12 serve as stators fixed on the fixed support member while maintaining the positional relationship of these elements.

[Second Embodiment]

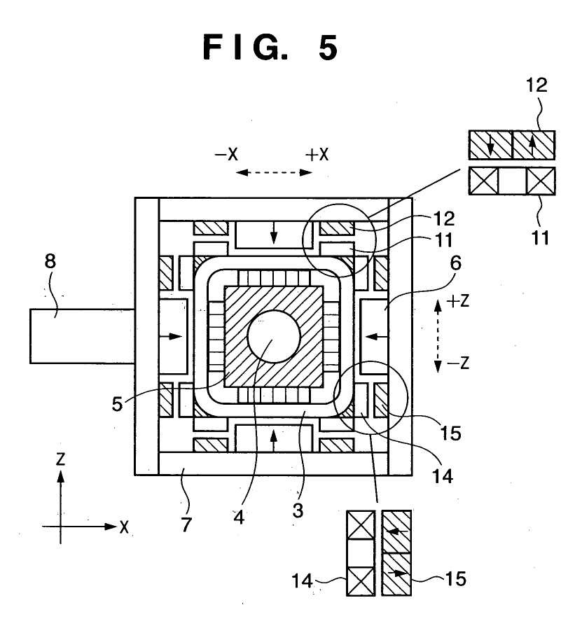

FIG. 5 is a view showing the internal arrangement of the annular linear motor viewed from an X-Z plane according to the second embodiment of the present invention.

In the first embodiment described above, the X annular coil 11 and the X moving element magnet 12 are arranged as driving means for driving the moving element in the ±X direction almost perpendicular to the main drive axis. However, in the second embodiment, a driving means is also arranged in the ±Z direction almost perpendicular to the main drive axis and X directions. Since the linear motor can drive in two directions (X and Z directions) perpendicular to each other to the main drive axis, the linear motor can drive in the three directions.

In detail, as shown in FIG. 5, the Z annular coil 14 which is a air-core coil bonds to the corner on the outer surface of the Y annular coil 3 via the insulating member 2. The Z moving element magnet two-dimensionally opposes the Z annular coil 11 via a predetermined gap (an almost constant gap in the X and Y directions). The Z moving element magnets are formed on the both sides of the Y moving element magnet 6. The pairs of the Z moving element magnets are fixed on the two surfaces of the magnet stationary plates 7 in parallel to the X-Y plane.

In the above arrangement, the driving force is generated by a Lorentz force in an interaction between the Z annular coil 14 and the Z moving element magnet 15, thereby generating the thrust in the +Z direction. That is, since the Z-motor driver (not shown) for supplying the driving current for exciting the Z annular coil 14 supplies the driving current to the Z annular coil 14, the magnet stationary plate 7, which is the moving element arm 8 is driven in the ±Z direction almost perpendicular to the main drive axis and the X direction. As a result, the linear motor can drive in the three-axis directions.

In the remaining arrangement, the same reference numerals denote the same parts and functions as in FIGS. 1 to 4B, and a repetitive description thereof is omitted.

[Third Embodiment]

FIG. 6 is a view showing the internal arrangement of the annular linear motor viewed from an X-Z plane according to the third embodiment of the present invention.

In the first and second embodiments, the Y moving element magnets 6 in the main drive axis direction are respectively arranged on the four surfaces of the magnet stationary plate 7 serving as the moving elements. However, in the third embodiment, as shown in FIG. 6, the lengths in parallel to an X-Y plane of a support member 16, Y annular coil 17, stator yoke 19, Y moving element magnet 20, and magnet stationary plate 21 are longer than those in parallel to a Y-Z plane. The Y moving element magnet 20 elongates along the long side of the magnet stationary plate 21.

Then, the Y moving element magnets 20 are respectively fixed on two surfaces on the long sides of the magnet stationary plates 21. An X annular coil 22 is bonded at the corner of the outer surface of the Y annular coil 17 via an insulating member. An X moving element magnet 23 two-dimensionally opposes the X annular coil 22 via a predetermined gap. The X moving element magnets 23 are fixed on the both sides of the Y moving element magnet 20.

In the above arrangement, the driving force is generated by a Lorentz force in an interaction between the coils 17 and 22 and the magnets 20 and 23, thereby generating the thrust in the ±X and ±Z directions. That is, since the motor driver (not shown) for supplying the driving current for exciting the coils 17 and 22 supplies the driving current to the coils 17 and 22, the magnet stationary plate 21, which is the moving element arm 8 is driven in the main drive axis and +X direction almost perpendicular to the main drive axis and the X direction. As a result, the linear motor can drive in the two-axis directions.

Furthermore, as described above, the linear motor may include only elements driving in the ±Y direction as shown in FIGS. 1 to 4B. Alternatively, the linear motor may be driven in two directions (the X and Z directions) respectively perpendicular to the main drive axis by adding the elements driving in the +Z direction as shown in FIG. 5.

In the above arrangement, the effective length of the Y moving element magnet 20 in the Y direction and the effective length of the X moving element magnet 23 in the X direction can be made long. Hence, the moving range of the moving element in each direction can be made large.

Furthermore, since the support member 16 is a rectangle whose long side extends in the X direction, a plurality of (e.g., three) cooling medium flow channels 18 can be arranged, thereby improving the cooling capability of the coil.

In the remaining arrangement, the same reference numerals denote the same parts and functions as in FIGS. 1 to 5, and a repetitive description thereof is omitted.

[Application Example]

For example, the linear motor according to this embodiment is used as a driving means of the stage device mounted on the exposure device for manufacturing the semiconductor device. The stage device includes a stage connected to the moving element arm 8 of the above-described linear motor, and relatively aligns a substrate (wafer) and/or master (reticle or mask) by driving the stage on the stage surface plate serving as a reference surface in at least a one-axis direction of the three-dimensional directions (X-, Y-, and Z-directions).

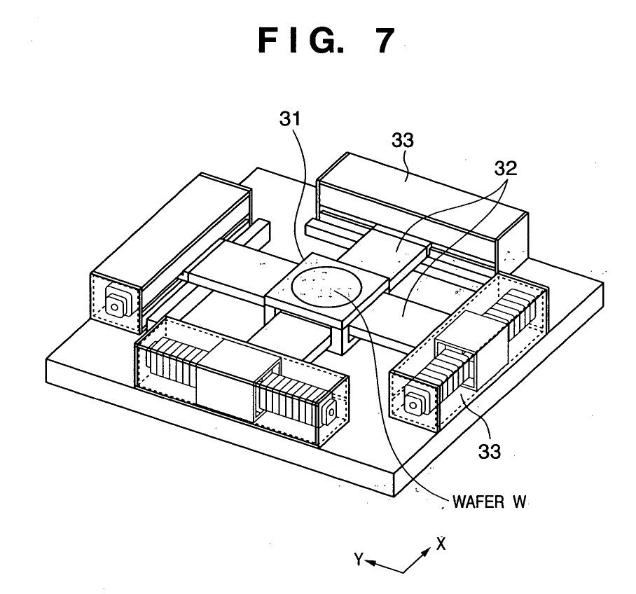

FIG. 7 is a view showing an example of the arrangement in which the linear motor in this embodiment is mounted on a stage device. In the stage device, a cross bar 32 moves a slider 31 serving as a stage moving portion on the X-Y plane. The slider 31 holds a wafer W, and the cross bars 32 are driven by linear motors 33 arranged on four surfaces. For example, a Z driving means in the direction other than the main drive axis (Y) direction is used for driving the slider in the Z direction. As for driving in the X direction, the Z driving means is used for correcting the master stage driving in the main drive axis (Y) and perpendicular (X) directions.

The exposure device includes the stage device, holds the substrate (wafer) on the chuck of the slider, drives and aligns the master (reticle or mask) in at least a one-axis direction of three-dimensional directions (X-, Y-, and Z-axis directions), and emits exposure light, thereby transferring the circuit pattern of the master to the wafer.

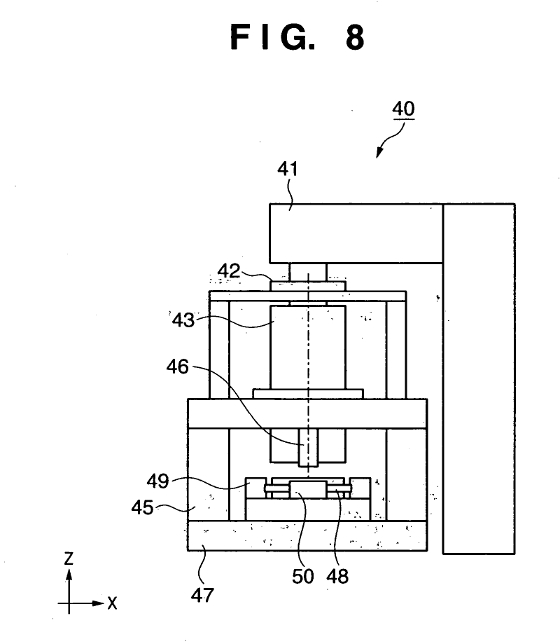

FIG. 8 shows an exposure device 40 for manufacturing the semiconductor device which uses the stage device as a wafer stage 44. The exposure device 40 is used for manufacturing a semiconductor device such as a semiconductor integrated circuit and a device on which a micropattern such as a micromachine and thin-film magnetic head is formed. The semiconductor wafer serving as the substrate is irradiated with the exposure light (this is a general term of visible light, ultraviolet light, EUV light, an X-ray, electron beam, charged particle beam, and the like) serving as exposure energy from an illumination system unit 41 via the reticle serving as the master and a reduction projection lens 43 (this is a general term of a refractive lens, reflection lens, reflection refractive lens system, charged particle lens, and the like) serving as the projection system. Hence, the pattern formed on the reticle serving as the master is projected and exposed. A reticle stage 42 aligns the reticle in response to the wafer on the basis of the measurement result obtained by an alignment scope 46.

In the exposure device 40, a moving guide 48 and the above linear motor 49 are fixed on a stage surface plate 47 arranged in an exposure device body 45. The linear motor 49 includes a linear motor stator and linear motor moving element. The linear motor stator and the linear motor moving element include a multiphase electromagnetic coil and a group of permanent magnets, respectively. Using the linear motor moving element as the moving portion, a moving stage 50 is connected to the moving guide 48 to move the moving guide 48 in the X-Y direction by driving the linear motor. The moving guide 48 is supported by a static pressure bearing on the upper surface of the stage surface plate 47 as the reference surface.

The moving stage 50 is supported by the static pressure bearing and driven by the linear motor 49, and moves in the X-Y direction using the moving guide 48 as the reference. The movement of the moving stage 50 is measured by using a mirror and laser interferometer fixed on the moving stage 50.

The wafer serving as the substrate is held on the chuck mounted on the moving stage 50. The pattern of the reticle serving as the master is reduced on each area on the wafer, and the pattern is transferred by a step-and-repeat or step-and-scan method by the illumination system unit 41 and reduction projection lens 43.

Note that the linear motor of the present invention can also be applied to the exposure device which exposes the resist by directly drawing the circuit pattern on the semiconductor wafer without using the mask.

[Device Manufacturing Method]

A semiconductor device manufacturing method using an exposure apparatus will be described next.

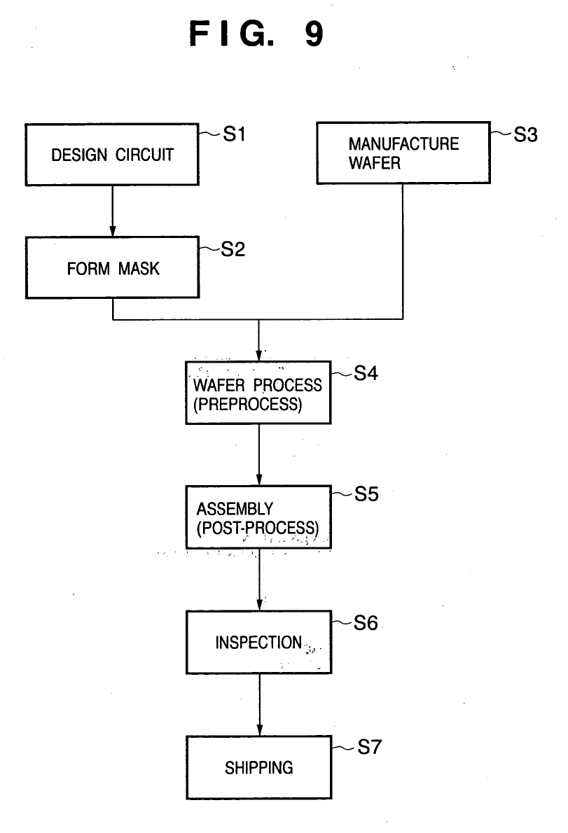

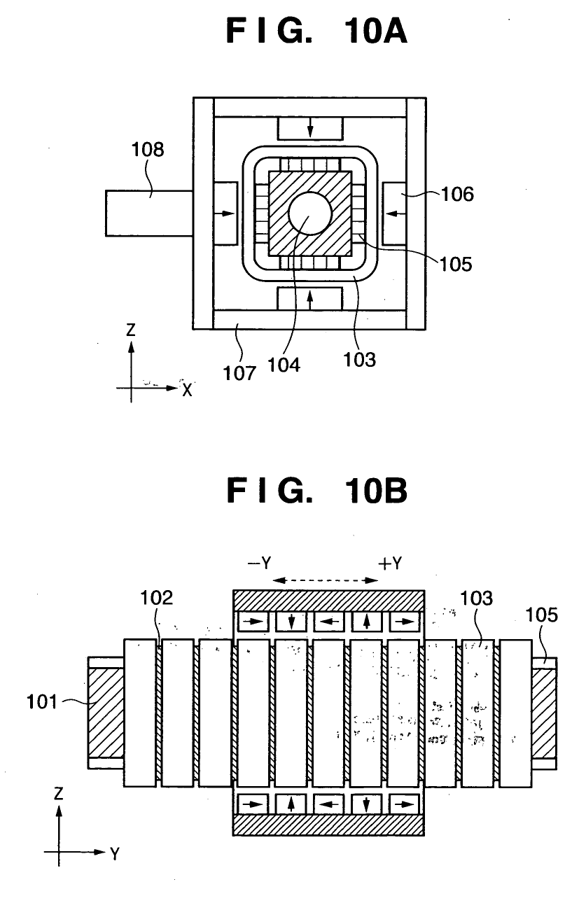

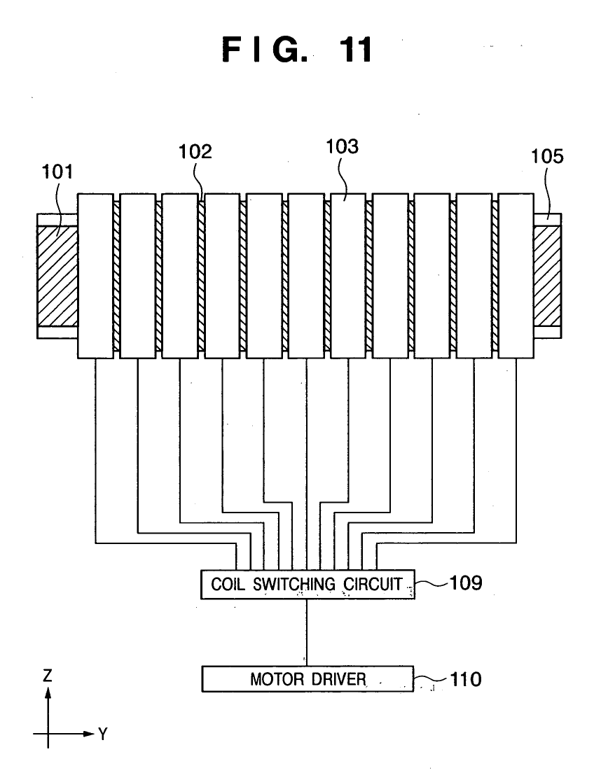

FIG. 9 shows the manufacturing flow of a semiconductor device. In step S1 (design circuit), a semiconductor device circuit is designed. In step S2 (fabricate mask), a mask is fabricated on the basis of the designed pattern. In step S3 (manufacture wafer), a wafer is manufactured by using a material such as silicon. In step S4 (wafer process) called a pre-process, an actual circuit is formed on the wafer by lithography using the prepared mask and wafer. In step S5 (assembly) called a post-process, a semiconductor chip is formed by using the wafer fabricated in step S4, and includes processes such as an assembly process (dicing and bonding) and packaging process (chip encapsulation). In step S6 (inspection), inspections such as the operation confirmation test and durability test of the semiconductor device manufactured in step 5 are conducted. The semiconductor device is completed through these steps, and is shipped in step S7.

The above wafer process in step S4 includes the following steps: oxidation step of oxidizing the surface of the wafer; CVD step of forming an insulating film on the wafer surface; electrode forming step of forming an electrode on the wafer by vapor deposition; ion-implanting step of implanting ions in the wafer; resist processing step of applying a photosensitive agent to the wafer; exposure step of transferring the circuit pattern of the mask to the wafer by the above-mentioned exposure apparatus; developing step of developing the exposed wafer; etching step of etching the resist except for the developed resist image; resist removing step of removing an unnecessary resist after etching. These steps are repeated to form multiple circuit patterns on the wafer.

The present invention is not limited to the above embodiments and various changes and modifications can be made within the spirit and scope of the present invention. Therefore, to apprise the public of the scope of the present invention the following claims are made.

What is claimed is:

1. A linear motor comprising:
first driving means including a first stator which is annularly formed about a first drive axis, and a first moving element which two-dimensionally opposes the first stator via a predetermined gap, said first driving means driving the first moving element in a main drive axis direction by exciting any one of the first stator and the first moving element; and
second-driving means including a second stator which is fixed to the first stator, and a second moving element which two-dimensionally opposes the second stator via a predetermined gap, said second driving means driving the second moving element in a second direction substantially perpendicular to the main drive axis direction by exciting any one of the second stator and the second moving element.

2. The linear motor according to claim 1, further comprising third driving means including a third stator which is fixed to the first stator, and a third moving element which two-dimensionally opposes the third stator via a predetermined gap, said third driving means driving the third moving element in a third direction almost perpendicular to the main drive axis direction and second direction by exciting any one of the third stator and the third moving element.

3. The linear motor according to claim 1, wherein
the first stator includes a first coil annularly winded about the first drive axis, and first energizing means for energizing the first coil, and
the first moving element includes a plurality of first permanent magnets opposing the first coil via a predetermined gap, and stationary portions which hold the first permanent magnets.

4. The linear motor according to claim 1, wherein
the second stator includes a second coil substantially integrally fixed to the first coil, and second energizing means for energizing the second coil, and
the second moving element includes a plurality of second permanent magnets opposing the second coil via a predetermined gap, and stationary portions which hold the second permanent magnets.

5. The linear motor according to claim 2, wherein
the third stator includes a third coil which is substantially integrally fixed to the first stator, and third energizing means for energizing the third coil, and
the third moving element includes a plurality of third permanent magnets opposing the third coil via a predetermined gap, and stationary portions which hold the third permanent magnets.

6. The linear motor according to claim 4, wherein the second and third coils are annular coils, the second coil includes a linear portion in substantially parallel to the main drive axis, and the second and third coils oppose each other in substantially parallel to a second direction, and
the third coil is arranged to include a linear portion in substantially parallel to the main drive axis.

7. The linear motor according to claim 4, wherein the stationary portion commonly supports the first to third permanent magnets.

8. The linear motor according to claim 1, wherein
the first moving element includes a first coil annularly winded about the first drive axis, and first energizing means for energizing the first coil, and
the first stator includes a plurality of first permanent magnets opposing the first coil via a predetermined gap, and stationary portions which hold the first permanent magnets.

9. The linear motor according to claim 1, wherein
the second moving element includes a second coil substantially integrally fixed to the first coil, and second energizing means for energizing the second coil, and
the second stator includes a plurality of second permanent magnets opposing the second coil via a predetermined gap, and stationary portions which hold the second permanent magnets.

10. The linear motor according to claim 2, wherein
the third moving element includes a third coil which is substantially integrally fixed to the first stator, and third energizing means for energizing the third coil, and
the third stator includes a plurality of third permanent magnets opposing the third coil via a predetermined gap, and stationary portions which hold the third permanent magnets.

11. A stage device comprising a linear motor of claim 1, and a stage driven by the linear motor.

12. An exposure device comprising a stage device of claim 11 aligns at least one of a substrate and a master.

13. A device manufacturing method comprising a step of manufacturing a device by using an exposure device of claim 12.
